(19) United States
(12) Patent Application Publication
(10) Pub. No.: US 2026/0062304 A1
(43) Pub. Date: Mar. 5, 2026

(54) LITHIUM CARBONATE AND USES THEREOF

(71) Applicant: TECHTRONIC CORDLESS GP, Anderson, SC (US)

(72) Inventors: Kai WANG, Dongguan City (CN); Denis Gaston FAUTEUX, Hong Kong (CN)

(21) Appl. No.: 19/104,131

(22) PCT Filed: Aug. 18, 2022
(86) PCT No.: PCT/CN2022/113427

§ 371 Date: Feb. 14, 2025

(51) Int. Cl. C01D 15/08; H01M 4/02; H01M 4/131; H01M 4/525; H01M 4/62

(52) U.S. Cl. CPC C01D 15/08; H01M 4/131; H01M 4/525; H01M 4/628; C01P 2004/03; C01P 2004/61; C01P 2004/62; C01P 2004/64; C01P 2006/12; C01P 2006/40; H01M 2004/028

(57) ABSTRACT

Exemplary lithium carbonate (Li₂CO₃) particles may comprise at least 98% by weight (wt %) lithium carbonate. Exemplary lithium carbonate (Li₂CO₃) particles may have a Dᵥ (50) between 0.08 μm and 0.43 μm. Exemplary lithium carbonate (Li₂CO₃) particles may have a Dₙ (50) between 0.015 μm and 0.5 μm. Exemplary lithium carbonate (Li₂CO₃) particles may have a BET surface area between 10 m²/g and 25 m²/g. Exemplary batteries may comprise a cathode, an anode, a separator sheet, and a non-aqueous electrolyte. Exemplary cathodes may have a cathode active material layer including a cathode active material and a plurality of lithium carbonate (Li₂CO₃) particles.

### FIELD

Materials, methods, and techniques disclosed herein relate to lithium carbonate. More specifically, the instant disclosure relates to the generation and properties of lithium carbonate, which may be used to prevent overcharge in lithium-ion secondary batteries.

### INTRODUCTION

Lithium secondary batteries have the potential to explode or catch fire when subjected to overcharging or overcurrent. Overcharging of lithium batteries may lead to irreversible damage to cell components and can cause safety problems.

### SUMMARY

In one aspect, a plurality of lithium carbonate (Li₂CO₃) particles is disclosed. The lithium carbonate particles may have a Dᵥ (50) between 0.08 μm and 0.43 μm. The lithium carbonate particles may have a Dₙ (50) between 0.015 μm and 0.5 μm. The lithium carbonate particles may have a BET surface area between 10 m²/g and 25 m²/g. In some instances, lithium carbonate particles may have a BET surface area between 15 m²/g and 25 m²/g. In some instances, the BET surface area is between 17.5 m²/g to 22.5 m²/g. The lithium carbonate particles may comprise at least 99 wt % lithium carbonate.

In another aspect, a method of preparing lithium carbonate is disclosed. The method may comprise a first process followed by a second process. The first process may comprise forming a first lithium carbonate dispersion by combining lithium carbonate particles in a first dispersion medium, where the lithium carbonate particles having a Dᵥ (50) between 5 μm and 8 μm. The first dispersion medium may comprise at least one of: methanol, ethanol, propanol, or N-methyl-2-pyrrolidone. The first process may further comprise forming a first milling suspension by adding a first plurality of zirconium oxide (ZrO₂) particles to the first lithium carbonate dispersion. The first plurality of zirconium oxide particles may have an average diameter between 1.00 mm and 1.80 mm. The first process may further comprise milling the first milling suspension at a first predetermined speed for a first predetermined period of time. The first predetermined speed may be between 500 rpm and 1500 rpm. The first predetermined period of time may be between 30 minutes and 300 minutes. The method may further comprise, before forming the first milling suspension, stirring the first lithium carbonate dispersion for 10 minutes to 20 minutes at 30 rpm to 1000 rpm.

The second process may comprise forming a second lithium carbonate dispersion by combining a plurality of lithium carbonate particles produced by the first process in a second dispersion medium. The second dispersion medium may comprise at least one of: methanol, ethanol, propanol, or N-methyl-2-pyrrolidone. The second process may further comprise forming a second milling suspension by adding a second plurality of zirconium oxide (ZrO₂) particles to the second lithium carbonate dispersion. The second plurality of zirconium oxide particles may have an average diameter between 0.20 mm and 1.20 mm. The second process may further comprise milling the second milling suspension at a second predetermined speed for a second predetermined period of time. The second predetermined speed may be between 1000 rpm and 2000 rpm. The second predetermined period of time may be between 60 minutes and 600 minutes. The second process may further comprise, before forming the second milling suspension, stirring the second lithium carbonate dispersion for 10 to 20 minutes at 1000 rpm to 2500 rpm. In some instances, the second predetermined speed may be between 1200 rpm and 1800 rpm, and the second predetermined period of time may be between 150 minutes and 550 minutes.

After the second process, the BET surface area of the lithium carbonate particles may have increased between 5-fold and 67-fold. After the second process, the lithium carbonate particles may have a BET surface area between 10 m²/g and 25 m²/g.

In another aspect, a battery is disclosed. The battery may comprise an anode, a cathode, a separator sheet, and a non-aqueous electrolyte. The anode may comprise an anode active material layer. The anode active material layer may comprise a binder, a conductive material, and an anode active material. The anode active material may comprise a silicon carbon composite. In some instances, the anode active material layer comprises 90 weight % (wt %) to 99 wt % of the silicon carbon composite. The cathode may comprise a cathode active material layer. The cathode active material layer may comprise a binder, a conductive material, a cathode active material, and a plurality of lithium carbonate (Li₂CO₃) particles. The cathode active material may comprise LiNi_{0.8}Co_{0.1}Mn_{0.1}O₂. In some instances, the cathode active material layer comprises 90 wt % to 99 wt % LiNi_{0.8}Co_{0.1}Mn_{0.1}O₂. The lithium carbonate particles may have a BET surface area between 10 m²/g and 25 m²/g. In some instances, the lithium carbonate particles have a BET surface area between 15 m²/g and 25 m²/g. In some instances, the lithium carbonate particles have a BET surface area between 17.5 m²/g and 22.5 m²/g. The lithium carbonate particles may comprise at least 99% lithium carbonate. The lithium carbonate particles may have Dᵥ (50) between 0.08 μm and 0.43 μm. The lithium carbonate particles may have a Dₙ (50) between 0.015 μm and 0.5 μm. The cathode may comprise 0.2 wt % to 1.2 wt % lithium carbonate particles.

In another aspect, a method of making a cathode for a lithium-ion battery is disclosed. The method of making the cathode may comprise coating a cathode slurry onto a cathode current collector. The cathode slurry may comprise a binder, a conductive material, a cathode active material, and a plurality of lithium carbonate (Li₂CO₃) particles. The cathode active material may comprise LiNi_{0.8}Co_{0.1}Mn_{0.1}O₂. In some instances, the cathode slurry comprises 90 wt % to 99 wt % LiNi_{0.8}Co_{0.1}Mn_{0.1}O₂. The lithium carbonate particles may have a BET surface area between 10 m²/g and 25 m²/g. In some instances, the lithium carbonate particles have a BET surface area between 15 m²/g and 25 m²/g. In some instances, the lithium carbonate particles have a BET surface area between 17.5 m²/g and 22.5 m²/g. The lithium carbonate particles may have Dᵥ (50) between 0.08 μm and 0.43 μm. The lithium carbonate particles may have a Dₙ (50) between 0.015 μm and 0.5 μm. The cathode slurry may comprise 0.2 wt % to 1.2 wt % lithium carbonate particles.

In another aspect, a method of making a battery is disclosed. The method of making the battery may comprise the method of making the cathode. The method of making the battery may further comprise a method of making an anode. The method of making an anode may comprise coating an anode slurry onto an anode current collector. The anode slurry may comprise a binder, a conductive material, and an anode active material. The anode active material may comprise a silicon carbon composite. The anode slurry may comprise 90 wt % to 99 wt % of the silicon carbon composite.

There is no specific requirement that a material, technique, or method relating to lithium carbonate include all of the details characterized herein, in order to obtain some benefit according to the present disclosure. Thus, the specific examples characterized herein are meant to be exemplary applications of the techniques described, and alternatives are possible.

### BRIEF DESCRIPTION OF THE DRAWINGS

The same sand milling methods were used for the data and images presented in the following FIGS. 1-16.

FIG. 1 shows a graph of lithium carbonate (Li₂CO₃) particle size change upon exemplary sand milling.

FIG. 2 shows a graph of a lithium carbonate particle size distribution and volume density (%) upon sand milling over time for samples A-E.

FIG. 3 shows a graph of the lithium carbonate particle size and distribution number density (%) upon sand milling over time for samples A-E.

FIG. 4 shows a graph of the lithium carbonate particle size distribution and volume density (%) upon sand milling over time for samples F-L.

FIG. 5 shows a graph of the lithium carbonate particle size distribution and corresponding number density (%) upon sand milling over time for samples F-L.

FIG. 6 shows a scanning electron microscopy (SEM) image of the changes particle size and morphology as a result of sand-milling over time.

FIG. 7 shows a graph illustrating the change in the BET surface area of the lithium carbonate particles upon sand-milling over time.

FIGS. 8-10 show graphs illustrating the 8.2 A-7.5V overcharge test results for group A, B, C, and E batteries. Group A batteries include 1 weight % (wt %) of milled Li₂CO₃ particles. Group B batteries include 0.5 wt % of milled Li₂CO₃ particles. Group C batteries include 1 wt % of non-milled Li₂CO₃ particles.

FIGS. 11-13 shows graphs illustrating the 12 A-5.1V overcharge test results for group A, B, C, and E batteries. Group A batteries include 1 wt % of milled Li₂CO₃ particles. Group B batteries include 0.5 wt % of milled Li₂CO₃ particles. Group C batteries include 1% of non-milled Li₂CO₃ particles. Group C batteries do not include any Li₂CO₃ particles.

FIGS. 14-16 shows graphs illustrating the 8.2 A-5.1V overcharge test results for group A, B, C, and E batteries. Group A batteries include 1 wt % of milled Li₂CO₃ particles. Group B batteries include 0.5 wt % of milled Li₂CO₃ particles. Group C batteries include 1 wt % of non-milled Li₂CO₃ particles. Group C batteries do not include any Li₂CO₃ particles.

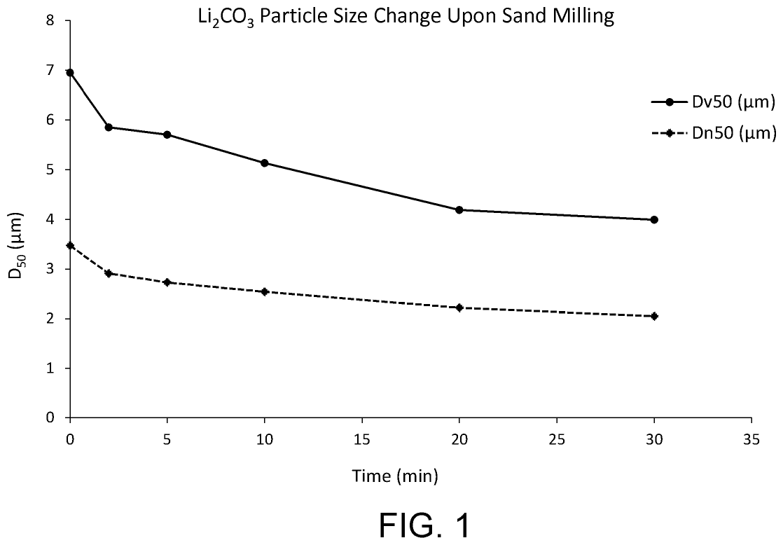

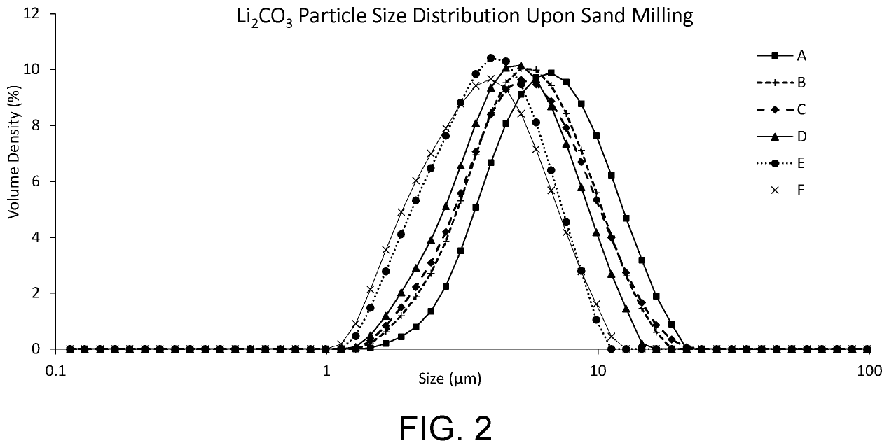

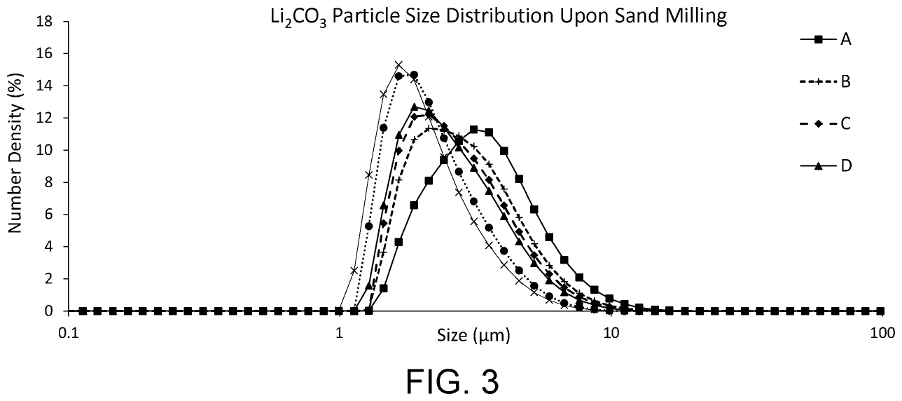

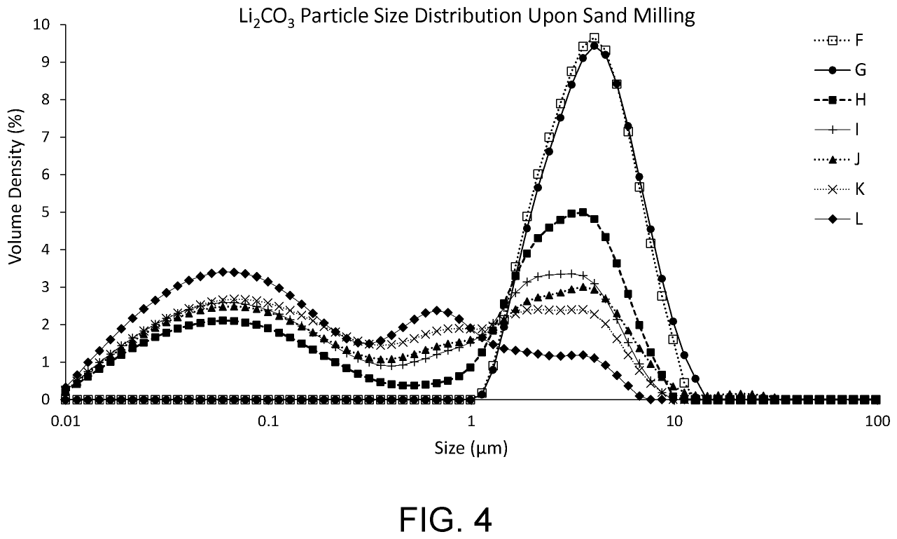

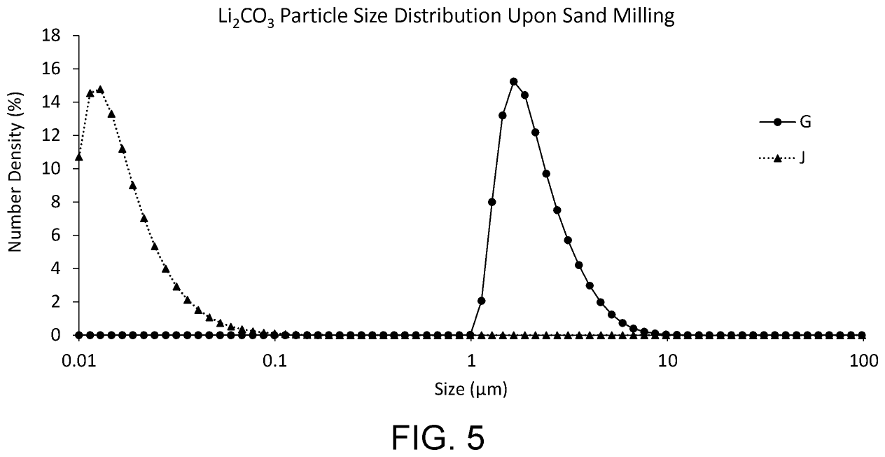

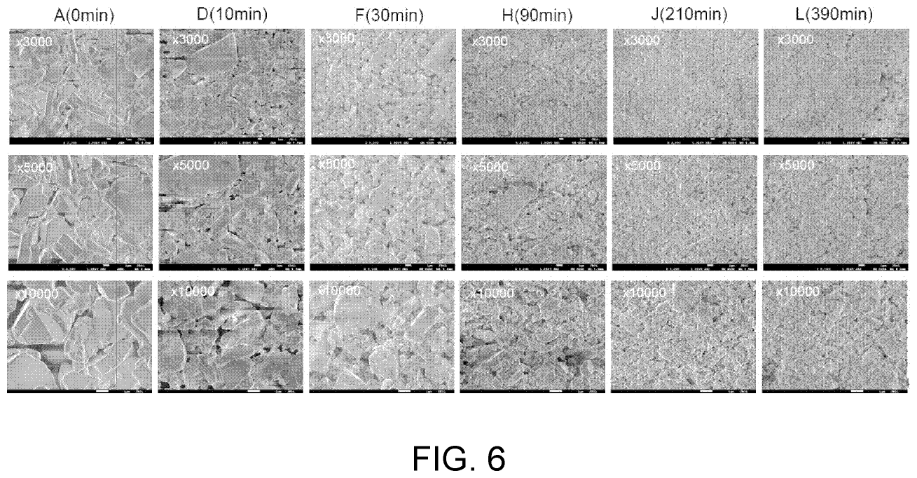

### DETAILED DESCRIPTION

Materials, methods, and techniques disclosed and contemplated herein relate to lithium carbonate particles (Li₂CO₃). Exemplary lithium carbonate particles may be particularly suited for use in battery-related applications. During battery charging, lithium carbonate is electrochemically oxidized to generate carbon dioxide gas. The generation of carbon dioxide by lithium carbonate increases pressure inside the battery. Sufficient gas generation by lithium carbonate enables current interruption to prevent overcharging. Lithium carbonate particles with a higher BET surface area have an enhanced ability to produce gas and thus an improved ability for preventing battery overcharge.

### I. Definitions

Unless otherwise defined, all technical and scientific terms used herein have the same meaning as commonly understood by one of ordinary skill in the art. In case of conflict, the present document, including definitions, will control. Example methods and materials are described below, although methods and materials similar or equivalent to those described herein can be used in practice or testing of the present disclosure. The materials, methods, and examples disclosed herein are illustrative only and not intended to be limiting.

The terms “comprise(s),” “include(s),” “having,” “has,” “can,” “contain(s),” and variants thereof, as used herein, are intended to be open-ended transitional phrases, terms, or words that do not preclude the possibility of additional acts or structures. The singular forms “a,” “an” and “the” include plural references unless the context clearly dictates otherwise. The present disclosure also contemplates other embodiments “comprising,” “consisting of” and “consisting essentially of,” the embodiments or elements presented herein, whether explicitly set forth or not.

Definitions of specific functional groups and chemical terms are described in more detail below. For purposes of this disclosure, the chemical elements are identified in accordance with the Periodic Table of the Elements, CAS version, Handbook of Chemistry and Physics, 75^{th} Ed., inside cover, and specific functional groups are generally defined as described therein.

For the recitation of numeric ranges herein, each intervening number there between with the same degree of precision is explicitly contemplated. For example, for the range of 6-9, the numbers 7 and 8 are contemplated in addition to 6 and 9, and for the range 6.0-7.0, the number 6.0, 6.1, 6.2, 6.3, 6.4, 6.5, 6.6, 6.7, 6.8, 6.9, and 7.0 are explicitly contemplated.

The modifier “about” used in connection with a quantity is inclusive of the stated value and has the meaning dictated by the context (for example, it includes at least the degree of error associated with the measurement of the particular quantity). The modifier “about” should also be considered as disclosing the range defined by the absolute values of the two endpoints. For example, the expression “from about 2 to about 4” also discloses the range “from 2 to 4.” The term “about” may refer to plus or minus 10% of the indicated number. For example, “about 10%” may indicate a range of 9% to 11%, and “about 1” may mean from 0.9-1.1. Other meanings of “about” may be apparent from the context, such as rounding off, so, for example “about 1” may also mean from 0.5 to 1.4.

### II. Exemplary Lithium Carbonate Particles

Exemplary lithium carbonate (Li₂CO₃) particles may have various chemical constituents and physical properties. Various aspects are discussed below.

Exemplary lithium carbonate (Li₂CO₃) particles comprise at least 98% by weight (wt %) lithium carbonate. In some instances, the lithium carbonate particles comprise at least 99 wt % lithium carbonate or at least 99.9 wt % lithium carbonate.

In some instances, exemplary lithium carbonate particles may comprise up to 2 wt % impurities. In various instances, exemplary lithium carbonate particles comprise no more than 2 wt % impurities; no more than 1.75 wt % impurities; no more than 1.5 wt % impurities; no more than 1.25 wt % impurities; no more than 1.0 wt % impurities; no more than 0.5 wt % impurities; no more than 0.25 wt % impurities; no more than 0.1 wt % impurities; or no more than 0.01 wt % impurities. Example impurities may include LiCl, LiHCO₃, LiOH, water, salts or oxides of a metal (e.g., Mg, Na, K, Cu, and Fe), or combinations thereof.

Dᵥ (50) is the volume median for particles, which represents that each volume of particles greater or smaller than the volume median value accounts for 50% of the total particle volume. Exemplary lithium carbonate particles may have a Dᵥ (50) between 0.08 μm and 0.43 μm. In various instances, the lithium particles may have a Dᵥ (50) between 0.1 μm and 0.4 μm; between 0.1 μm and 0.35 μm; between 0.15 μm and 0.35 μm; between 0.15 μm and 0.4 μm; between 0.2 μm and 0.4 μm; between 0.2 μm and 0.35 μm; or between 0.25 μm and 0.35 μm. In various instances, the lithium carbonate particles may have a Dᵥ (50) of no greater than 0.43 μm; no greater than 0.4 μm; no greater than 0.35 μm; no greater than 0.3 μm; no greater than 0.25 μm; no greater than 0.2 μm; no greater than 0.15 μm; no greater than 0.1 μm; or no greater than 0.08 μm. In various instances, the lithium carbonate particles may have a Dᵥ (50) of no less than 0.08 μm; no less than 0.1 μm; no less than 0.15 μm; no less than 0.2 μm; no less than 0.25 μm; no less than 0.3 μm; no less than 0.35 μm; no less than 0.4 μm; or no less than 0.43 μm.

Dₙ (50) is the number median for particles, which represents that each number of particles greater or smaller than the number median value accounts for 50% of the total particle number. Exemplary lithium carbonate particles may have a Dₙ (50) between 0.015 μm and 0.5 μm. In various instances, the lithium carbonate particles may have a Dₙ (50) between 0.015 μm and 0.45 μm; between 0.02 μm and 0.4 μm; between 0.025 μm and 0.35 μm; between 0.03 μm and 0.3 μm; between 0.035 μm and 0.25 μm; between 0.04 μm and 0.2 μm; or between 0.05 μm and 0.1 μm. In various instances, the lithium carbonate particles may have a Dₙ (50) of no greater than 0.5 μm; no greater than 0.45 μm; no greater than 0.4 μm; no greater than 0.3 μm; no greater than 0.25 μm; no greater than 0.2 μm; no greater than 0.1 μm; no greater than 0.075 μm; no greater than 0.05 μm; no greater than 0.04 μm; no greater than 0.03 μm; no greater than 0.02 μm; or no greater than 0.015 μm. In various instances, the lithium carbonate particles may have a Dₙ (50) of no less than 0.015 μm; no less than 0.02 μm; no less than 0.03 μm; no less than 0.04 μm; no less than 0.05 μm; no less than 0.075 μm; no less than 0.1 μm; no less than 0.2 μm; no less than 0.3 μm; no less than 0.4 μm; or no less than 0.5 μm.

Exemplary lithium carbonate particles may have a BET surface area (i.e., surface area to weight ratio) between 10 m²/g and 40 m²/g. In various instances, the lithium carbonate particles may have a BET surface area between 10 m²/g and 35 m²/g; between 10 m²/g and 30 m²/g; between 15 m²/g and 30 m²/g; between 15 m²/g and 25 m²/g; or between 17.5 m²/g and 22.5 m²/g. In various instances, the lithium carbonate particles may have a BET surface area of no greater than 40 m²/g; no greater than 35 m²/g; no greater than 30 m²/g; no greater than 25 m²/g; no greater than 22.5 m²/g; no greater than 20 m²/g; no greater than 17.5 m²/g; no greater than 15 m²/g; or no greater than 10 m²/g. In various instances, the lithium carbonate particles may have a BET surface area of no less than 10 m²/g; no less than 15 m²/g; no less than 17.5 m²/g; no less than 20 m²/g; no less than 22.5 m²/g; no less than 25 m²/g; no less than 30 m²/g; no less than 35 m²/g; or no less than 40 m²/g.

### III. Exemplary Methods for Preparing Lithium Carbonate Particles

Exemplary methods can be used to prepare lithium carbonate particles. Various aspects are discussed below.

Generally, exemplary methods for preparing lithium carbonate particles may comprise a first process followed by a second process.

### A. Exemplary First Processes

Exemplary first processes may comprise forming a first lithium carbonate dispersion by combining “raw” lithium carbonate (Li₂CO₃) particles in a first dispersion medium, forming a first milling suspension by adding a first plurality of zirconium oxide (ZrO₂) particles to the first lithium carbonate dispersion, and milling the first milling suspension at a first predetermined speed for a first predetermined period of time.

Exemplary first dispersion mediums may include polar organic solvents. Exemplary polar organic solvents include methanol (MeOH), ethanol (EtOH), isopropanol (i-PrOH), N-Methyl-2-pyrrolidone (NMP), and combinations thereof.

Exemplary raw lithium carbonate (Li₂CO₃) particles for combining in the first dispersion medium may have a Dᵥ (50) between 5 μm and 8 μm. In various instances, the raw lithium carbonate particles may have a Dᵥ (50) between 5.5 μm and 8 μm; between 5.5 μm and 7.5 μm; between 6 μm and 7.5 μm; or between 6 μm and 7 μm. In various instances, the raw lithium carbonate particles may have a Dᵥ (50) of no greater than 8 μm; no greater than 7.5 μm; no greater than 7 μm; no greater than 6.5 μm; no greater than 6 μm; no greater than 5.5 μm; or no greater than 5 μm. In various instances, the raw lithium carbonate particles may have a Dᵥ (50) of no less than 5 μm; no less than 5.5 μm; no less than 6 μm; no less than 6.5 μm; no less than 7 μm; no less than 7.5 μm; or no less than 8 μm.

In some instances, exemplary methods may comprise, before forming the first milling suspension, stirring the first lithium carbonate dispersion. Before forming the first milling suspension, the first lithium carbonate dispersion may be stirred for 10 minutes to 20 minutes. In various instances, before forming the first milling suspension, the first lithium carbonate dispersion may be stirred for 10 minutes to 19 minutes; 10 minutes to 18 minutes; 11 minutes to 17 minutes; 12 minutes to 16 minutes; or 13 minutes to 15 minutes. In various instances, before forming the first milling suspension, the first lithium carbonate dispersion may be stirred for no greater than 20 minutes; no greater than 19 minutes; no greater than 18 minutes; no greater than 17 minutes; no greater than 16 minutes; no greater than 15 minutes; no greater than 14 minutes; no greater than 13 minutes; no greater than 12 minutes; no greater than 11 minutes; or no greater than 10 minutes. In various instances, before forming the first milling suspension, the first lithium carbonate dispersion may be stirred for no less than 10 minutes; no less than 11 minutes; no less than 12 minutes; no less than 13 minutes; no less than 14 minutes; no less than 15 minutes; no less than 16 minutes; no less than 17 minutes; no less than 18 minutes; no less than 19 minutes; or no less than 20 minutes.

Before forming the first milling suspension, the first lithium carbonate dispersion may be stirred at a speed of 30 rotations per minute (rpm) to 1000 rpm. In various instances, before forming the first milling suspension, the first lithium carbonate dispersion may be stirred at a speed of 50 rpm to 1000 rpm; 100 rpm to 950 rpm; 150 rpm to 950 rpm; 200 rpm to 800 rpm; 250 rpm to 750 rpm; 300 rpm to 700 rpm; 350 rpm to 650 rpm; 400 rpm to 600 rpm; or 450 rpm to 550 rpm. In various instances, before forming the first milling suspension, the first lithium carbonate dispersion may be stirred at a speed of no greater than 1000 rpm; no greater than 950 rpm; no greater than 900 rpm; no greater than 850 rpm; no greater than 800 rpm; no greater than 750 rpm; no greater than 700 rpm; no greater than 650 rpm; no greater than 600 rpm; no greater than 550 rpm; no greater than 500 rpm; no greater than 450 rpm; no greater than 400 rpm; no greater than 350 rpm; no greater than 300 rpm; no greater than 250 rpm; no greater than 200 rpm; no greater than 150 rpm; no greater than 100 rpm no greater than 50 rpm; or no greater than 30 rpm. In various instances, before forming the first milling suspension, the first lithium carbonate dispersion may be stirred at a speed of no less than 30 rpm; no less than 50 rpm; no less than 100 rpm; no less than 150 rpm; no less than 200 rpm; no less than 250 rpm; no less than 300 rpm; no less than 350 rpm; no less than 400 rpm; no less than 450 rpm; no less than 500 rpm; no less than 550 rpm; no less than 600 rpm; no less than 650 rpm; no less than 700 rpm; no less than 750 rpm; no less than 800 rpm; no less than 850 rpm; no less than 900 rpm; no less than 950 rpm; or no less than 1000 rpm.

Exemplary methods may comprise forming a first milling suspension by adding a first plurality of zirconium oxide (ZrO₂) particles to the first lithium carbonate dispersion.

In various instances, the first plurality of zirconium oxide (ZrO₂) particles added to the first lithium carbonate dispersion may have an average diameter between 1.00 mm and 1.80 mm. In various instances, the first plurality of zirconium oxide particles has an average diameter between 1.05 mm and 1.75 mm; between 1.10 mm and 1.70 mm; between 1.15 mm and 1.65 mm; between 1.20 mm and 1.60 mm; between 1.25 mm and 1.55 mm; between 1.30 mm and 1.50 mm; or between 1.35 and 1.55. In various instances, the first plurality of zirconium oxide particles has an average diameter of no greater than 1.00 mm; no greater than 1.20 mm; no greater than 1.30 mm; no greater than 1.40 mm; no greater than 1.50 mm; no greater than 1.60 mm; no greater than 1.70 mm; or no greater than 1.80 mm. In various instances, the first plurality of zirconium oxide particles has an average diameter of no less than 1.00 mm; no less than 1.10 mm; no less than 1.20 mm; no less than 1.30 mm; no less than 1.40 mm; no less than 1.50 mm; no less than 1.60 mm; or no less than 1.80 mm.

In various instances, the lithium carbonate particles may be present in the first milling suspension at a weight percent (wt %) of 15 wt % to 45 wt %. In various instances, the lithium carbonate particles may be present in the first milling suspension at a weight percent of 15 wt % to 40 wt %; 20 wt % to 45 wt %; 15 wt % to 30 wt %; 30 wt % to 45 wt %; 15 wt % to 25 wt %; 25 wt % to 35 wt %; or 35 wt % to 45 wt %. In various instances, the lithium carbonate particles may be present in the first milling suspension at a weight percent of no greater than 45 wt %; no greater than 40 wt %; no greater than 35 wt %; no greater than 30 wt %; no greater than 25 wt %; no greater than 20 wt %; or no greater than 16 wt %. In various instances, the lithium carbonate particles are present in the first milling suspension at a weight percent of no less than 15 wt %; no less than 20 wt %; no less than 25 wt %; no less than 30 wt %; no less than 35 wt %; no less than 40 wt %; or no less than 44 wt %.

In various instances, the weight ratio of the first plurality of zirconium oxide particles to the lithium carbonate particles in the first milling suspension is 1:1 to 1:6. In various instances, the weight ratio of the first plurality of zirconium oxide particles to the lithium carbonate particles in the first milling suspension is 1:1 to 1:5; 1:2 to 1:5; 1:2 to 1:4; or 1:2 to 1:3. In various instances, the weight ratio of the first plurality of zirconium oxide particles to the lithium carbonate particles in the first milling suspension is no greater than 1:6; no greater than 1:5; no greater than 1:4; no greater than 1:3; no greater than 1:2; or no greater than 1:1. In various instances, the weight ratio of the first plurality of zirconium oxide particles to the lithium carbonate particles in the first milling suspension is no less than 1:1; no less than 1:2; no less than 1:3; no less than 1:4; no less than 1:5; or no less than 1:6.

Exemplary methods may comprise milling the first milling suspension at a first predetermined speed for a first predetermined period of time.

The first predetermined milling speed for sand milling may be between 500 rotations per minute (rpm) and 1500 rpm. In various instances, the first predetermined milling speed is between 600 rpm and 1500 rpm; between 600 rpm and 1400 rpm; between 700 rpm and 1400 rpm; between 700 rpm and 1300 rpm; between 800 rpm and 1300 rpm; between 800 rpm and 1200 rpm; between 900 rpm and 1200 rpm; or between 900 rpm and 1100 rpm. In various instances, the first predetermined milling speed is no greater than 1500 rpm; no greater than 1400 rpm; no greater than 1300 rpm; no greater than 1200 rpm; no greater than 1100 rpm; no greater than 1000 rpm; no greater than 900 rpm; no greater than 800 rpm; no greater than 700 rpm; no greater than 600 rpm; or no greater than 500 rpm. In various instances, the first predetermined milling speed is no less than 500 rpm; no less than 600 rpm; no less than 700 rpm; no less than 800 rpm; no less than 900 rpm; no less than 1000 rpm; no less than 1100 rpm; no less than 1200 rpm; no less than 1300 rpm; or no less than 1500 rpm.

The first predetermined milling time period for sand milling may be between 30 minutes and 300 minutes. In various instances, the first predetermined period of milling time is between 40 minutes and 300 minutes; between 50 minutes and 250 minutes; between 60 minutes and 200 minutes; between 70 minutes and 150 minutes; between 80 minutes and 100 minutes. In various instances, the first predetermined period of milling time is no greater than 300 minutes; no greater than 250 minutes; no greater than 200 minutes; no greater than 150 minutes; no greater than 100 minutes; no greater than 90 minutes; no greater than 80 minutes; no greater than 70 minutes; no greater than 60 minutes; no greater than 50 minutes; no greater than 40 minutes; or no greater than 30 minutes. In various instances, the first predetermined period of milling time is no less than 30 minutes; no less than 40 minutes; no less than 50 minutes; no less than 60 minutes; no less than 70 minutes; no less than 80 minutes; no less than 90 minutes; no less than 100 minutes; no less than 150 minutes; no less than 200 minutes; no less than 250 minutes; or no less than 300 minutes.

The temperature of the first milling suspension, before, during, or after milling, may be between 15° C. and 50° C. In various instances, the temperature of the first milling suspension may be between 20° C. and 50° C.; between 20° C. and 45° C.; between 25° C. and 45° C.; between 25° C. and 40° C.; or between 30° C. and 40° C. In various instances, the temperature of the first milling suspension may be no greater than 50° C.; no greater than 45° C.; no greater than 40° C.; no greater than 35° C.; no greater than 30° C.; no greater than 25° C.; no greater than 20° C.; or no greater than 15° C.

For exemplary first processes, the temperature of the environment during milling may be from 25° C. to 45° C. In various instances, for the first process, the temperature of the environment during milling may be from 25° C. to 40° C.; from 25° C. to 35° C.; or from 30° C. to 35° C. In various instances, for the first process, the temperature of the environment during milling may be no greater than 40° C.; no greater than 35° C.; no greater than 30° C.; or no greater than 25° C. In various instances, the temperature of the environment during milling is no less than 25° C.; no less than 30° C.; no less than 35° C.; or no less than 40° C.

For exemplary first processes, the humidity of the environment during milling may be less than 10%. In various instances, for the first process, the humidity of the environment during milling may be less than 9%; less than 8%; less than 7%; less than 6%; or less than 5%. In various instances, for the first process, the humidity of the environment during milling may be no greater than 10%; no greater than 9%; no greater than 8%; no greater than 7%; no greater than 6%; or no greater than 5%.

### B. Exemplary Second Processes

Exemplary second processes may comprise forming a second lithium carbonate dispersion by combining a plurality of lithium carbonate particles produced by the first process in a second dispersion medium, forming a second milling suspension by adding a second plurality of zirconium oxide (ZrO₂) particles to the second lithium carbonate dispersion, and milling the second milling suspension at a second predetermined speed for a second predetermined period.

Exemplary second dispersion mediums may include polar organic solvents. Exemplary polar organic solvents include methanol (MeOH), ethanol (EtOH), isopropanol (i-PrOH), N-methyl-2-pyrrolidone (NMP), and combinations thereof.

In some instances, exemplary methods may comprise, before forming the second milling suspension, stirring the second lithium carbonate dispersion. Before forming the second milling suspension, the second lithium carbonate dispersion may be stirred for 10 minutes to 20 minutes. In various instances, before forming the second milling suspension, the second lithium carbonate dispersion may be stirred for 10 minutes to 19 minutes; 10 minutes to 18 minutes; 11 minutes to 17 minutes; 12 minutes to 16 minutes; or 13 minutes to 15 minutes. In various instances, before forming the second milling suspension, the second lithium carbonate dispersion may be stirred for no greater than 20 minutes; no greater than 19 minutes; no greater than 18 minutes; no greater than 17 minutes; no greater than 16 minutes; no greater than 15 minutes; no greater than 14 minutes; no greater than 13 minutes; no greater than 12 minutes; no greater than 11 minutes; or no greater than 10 minutes. In various instances, before forming the second milling suspension, the second lithium carbonate dispersion may be stirred for no less than 10 minutes; no less than 11 minutes; no less than 12 minutes; no less than 13 minutes; no less than 14 minutes; no less than 15 minutes; no less than 16 minutes; no less than 17 minutes; no less than 18 minutes; no less than 19 minutes; or no less than 20 minutes.

Before forming the second milling suspension, the second lithium carbonate dispersion may be stirred at a speed of 1000 rotations per minute (rpm) to 2500 rpm. In various instances, before forming the second milling suspension, the second lithium carbonate dispersion may be stirred at a speed of 1100 rpm to 2500 rpm; 1200 rpm to 2400 rpm; 1300 rpm to 2300 rpm; 1400 rpm to 2200 rpm; 1500 rpm to 2100 rpm; 1600 rpm to 2000 rpm; or 1700 rpm to 1900 rpm. In various instances, before forming the second milling suspension, the second lithium carbonate dispersion may be stirred at a speed of no greater than 2500 rpm; no greater than 2400 rpm; no greater than 2300 rpm; no greater than 2200 rpm; no greater than 2100 rpm; no greater than 2000 rpm; no greater than 1900 rpm; no greater than 1800 rpm; no greater than 1700 rpm; no greater than 1600 rpm; no greater than 1500 rpm; no greater than 1400 rpm; no greater than 1300 rpm; no greater than 1200 rpm; no greater than 1100 rpm; or no greater than 1000 rpm. In various instances, before forming the second milling suspension, the second lithium carbonate dispersion may be stirred at a speed of no less than 1000 rpm; no less than 1100 rpm; no less than 1200 rpm; no less than 1300 rpm; no less than 1400 rpm; no less than 1500 rpm; no less than 1600 rpm; no less than 1700 rpm; no less than 1800 rpm; no less than 1900 rpm; no less than 2000 rpm; no less than 2100 rpm; no less than 2200 rpm; no less than 2300 rpm; no less than 2400 rpm; or no less than 2500 rpm.

Exemplary methods may comprise forming a second milling suspension by adding a second plurality of zirconium oxide (ZrO₂) particles to the second lithium carbonate dispersion.

In various instances, the second plurality of zirconium oxide (ZrO₂) particles added to the second lithium carbonate dispersion may have an average diameter between 0.20 mm and 1.20 mm. In various instances, the second plurality of zirconium oxide particles have an average diameter between 0.25 mm and 1.15 mm; between 0.30 mm and 1.10 mm; between 0.35 mm and 1.05 mm; between 0.40 mm and 1.00 mm; between 0.45 mm and 0.95 mm; between 0.50 mm and 0.90 mm; between 0.55 and 0.85; or between 0.60 and 0.80. In various instances, the second plurality of zirconium oxide particles may have an average diameter of no greater than 1.20 mm; no greater than 1.10 mm; no greater than 1.00 mm; no greater than 0.90 mm; no greater than 0.80 mm; no greater than 0.70 mm; no greater than 0.60 mm; no greater than 0.50 mm; no greater than 0.40 mm; no greater than 0.30 mm; or no greater than 0.20 mm. In various instances, the second plurality of zirconium oxide particles may have an average diameter of no less than 0.20 mm; no less than 0.30 mm; no less than 0.40 mm; no less than 0.50 mm; no less than 0.60 mm; no less than 0.70 mm; no less than 0.80 mm; no less than 0.90 mm; no less than 1.00 mm; no less than 1.10 mm; or no less than 1.20 mm.

In various instances, the lithium carbonate particles may be present in the second milling suspension at a weight percent (wt %) of 15 wt % to 45 wt %. In various instances, the lithium carbonate particles may be present in the second milling suspension at a weight percent of 15 wt % to 40 wt %; 20 wt % to 45 wt %; 15 wt % to 30 wt %; 30 wt % to 45 wt %; 15 wt % to 25 wt %; 25 wt % to 35 wt %; or 35 wt % to 45 wt %. In various instances, the lithium carbonate particles may be present in the second milling suspension at a weight percent of no greater than 45 wt %; no greater than 40 wt %; no greater than 35 wt %; no greater than 30 wt %; no greater than 25 wt %; no greater than 20 wt %; or no greater than 16 wt %. In various instances, the lithium carbonate particles are present in the second milling suspension at a weight percent of no less than 15 wt %; no less than 20 wt %; no less than 25 wt %; no less than 30 wt %; no less than 35 wt %; no less than 40 wt %; or no less than 44 wt %.

In various instances, the weight ratio of the second plurality of zirconium oxide particles to the lithium carbonate particles in the second milling suspension is 1:1 to 1:6. In various instances, the weight ratio of the second plurality of zirconium oxide particles to the lithium carbonate particles in the second milling suspension is 1:1 to 1:5; 1:2 to 1:5; 1:2 to 1:4; or 1:2 to 1:3. In various instances, the weight ratio of the second plurality of zirconium oxide particles to the lithium carbonate particles in the second milling suspension is no greater than 1:6; no greater than 1:5; no greater than 1:4; no greater than 1:3; no greater than 1:2; or no greater than 1:1. In various instances, the weight ratio of the second plurality of zirconium oxide particles to the lithium carbonate particles in the second milling suspension is no less than 1:1; no less than 1:2; no less than 1:3; no less than 1:4; no less than 1:5; or no less than 1:6.

The second predetermined milling speed may be between 1000 rpm and 2000 rpm. In various instances, the second predetermined milling speed is between 1000 rpm and 1900 rpm; between 1100 rpm and 1900 rpm; between 1100 rpm and 1800 rpm; between 1200 rpm and 1800 rpm; between 1200 rpm and 1700 rpm; between 1300 rpm and 1700 rpm; between 1300 rpm and 1600 rpm; between 1400 rpm and 1600 rpm; between 850 rpm and 1200 rpm; or between 900 rpm and 1100 rpm. In various instances, the second predetermined milling speed is no greater than 2000 rpm; no greater than 1900 rpm; no greater than 1800 rpm; no greater than 1700 rpm; no greater than 1600 rpm; no greater than 1500 rpm; no greater than 1400 rpm; no greater than 1300 rpm; no greater than 1200 rpm; no greater than 1100 rpm; or no greater than 1000 rpm. In various instances, the second predetermined milling speed is no less than 1000 rpm; no less than 1100 rpm; no less than 1200 rpm; no less than 1300 rpm; no less than 1400 rpm; no less than 1500 rpm; no less than 1600 rpm; no less than 1700 rpm; no less than 1800 rpm; no less than 1900 rpm; or no less than 2000 rpm.

The second predetermined milling time period for sand milling may be between 60 minutes and 600 minutes. In various instances, the second predetermined milling time period may be between 75 minutes and 600 minutes; between 100 minutes and 600 minutes; between 150 minutes and 550 minutes; between 200 minutes and 500 minutes; between 250 minutes and 450 minutes; between 300 minutes and 400 minutes; or between 350 minutes and 400 minutes. In various instances, the second predetermined milling time period may be no greater than 600 minutes; no greater than 550 minutes; no greater than 500 minutes; no greater than 450 minutes; no greater than 400 minutes; no greater than 350 minutes; no greater than 300 minutes; no greater than 250 minutes; no greater than 200 minutes; no greater than 150 minutes; no greater than 100 minutes; no greater 75 minutes; or no greater than 60 minutes. In various instances, the second predetermined milling time period may be no less than 60 minutes; no less than 75 minutes; no less than 100 minutes; no less than 150 minutes; no less than 200 minutes; no less than 250 minutes; no less than 300 minutes; no less than 350 minutes; no less than 400 minutes; no less than 450 minutes; no less than 500 minutes; no less than 550 minutes; or no less than 600 minutes.

The temperature of the second milling suspension, before, during or after milling, may be between 20° C. and 40° C. In various instances, the temperature of the second milling suspension may be between 25° C. and 40° C.; between 25° C. and 35° C.; or between 30° C. and 35° C. In various instances, the temperature of the second milling suspension may be no greater than 40° C.; no greater than 35° C.; no greater than 30° C.; no greater than 25° C.; or no greater than 20° C. In various instances, the temperature of the second milling suspension may be no less than 20° C.; no less than 25° C.; no less than 30° C.; no less than 35° C.; or no less than 40° C.

For exemplary second processes, the temperature of the environment during milling is from 25° C. to 45° C. In various instances, for the second process, the temperature of the environment during milling is from 25° C. to 40° C.; from 25° C. to 35° C.; or from 30° C. to 35° C. In various instances, for the second process, the temperature of the environment during milling is no greater than 40° C.; no greater than 35° C.; no greater than 30° C.; or no greater than 25° C. In various instances, for the second process, the temperature of the environment during milling is no less than 25° C.; no less than 30° C.; no less than 35° C.; or no less than 40° C.

For exemplary second processes, the humidity of the environment during milling may be less than 10%. In various instances, for the second process, the humidity of the environment during milling may be less than 9%; less than 8%; less than 7%; less than 6%; or less than 5%. In various instances, for the second process, the humidity of the environment during milling may be no greater than 10%; no greater than 9%; no greater than 8%; no greater than 7%; no greater than 6%; or no greater than 5%.

After the second process, the lithium particles may be dried at a suitable drying temperature for a suitable drying time period. Typically, drying operations are performed when using wet milling techniques.

In various instances, after the second process, the drying temperature of the lithium carbonate particles may be from 85° C. to 140° C. In various instances, the drying temperature may be from 85° C. to 135° C.; from 90° C. to 130° C.; from 95° C. to 125° C.; from 100° C. to 120° C.; or from 105° C. to 115° C. In various instances, the drying temperature may be no greater than 140° C.; no greater than 135° C.; no greater than 130° C.; no greater than 125° C.; no greater than 120° C.; no greater than 115° C.; no greater than 110° C.; no greater than 105° C.; no greater than 100° C.; no greater than 95° C.; no greater than 90° C.; or no greater than 85° C. In various instances, the drying temperature may be no less than 85° C.; no less than 90° C.; no less than 95° C.; no less than 100° C.; no less than 105° C.; no less than 110° C.; no less than 115° C.; no less than 120° C.; no less than 125° C.; no less than 130° C.; no less than 135° C.; or no less than 140° C.

In various instances, after the second process, the drying time period for the lithium carbonate particles may be from 12 hours (h) to 24 h. In various instances, the drying time period may be from 12 h to 23 h; from 14 h to 22 h; from 15 h to 21 h; from 16 h to 20 h; or from 17 h to 19 h. In various instances, the drying time period may be no greater than 24 h; no greater than 23 h; no greater than 22 h; no greater than 21 h; no greater than 20 h; no greater than 19 h; no greater than 18 h; no greater than 17 h; no greater than 16 h; no greater than 15 h; no greater than 14 h; no greater than 13 h; or no greater than 12 h. In various instances, the drying time period may be no less than 12 h; no less than 13 h; no less than 14 h; no less than 15 h; no less than 16 h; no less than 17 h; no less than 18 h; no less than 19 h; no less than 20 h; no less than 21 h; no less than 22 h; no less than 23 h; or no less than 24 h.

Exemplary methods may increase a BET surface area of the lithium carbonate particles between 5-fold and 62-fold when comparing the BET surface area of the lithium carbonate particles before the exemplary operations and after the exemplary operations. In various instances, the BET surface area of the lithium carbonate particles may have increased between 5 fold and 62 fold; between 5 fold and 30 fold; between 30 fold and 60 fold; between 10 fold and 60 fold; between 40 fold and 60 fold; or between 45 fold and 62 fold. In various instances, the BET surface area of the lithium carbonate particles may have increased no more than 60 fold; no more than 55 fold; no more than 50 fold; no more than 45 fold; no more than 40 fold; no more than 35 fold; no more than 30 fold; no more than 25 fold; no more than 20 fold; no more than 15 fold; or no more than 10 fold. In various instances, the BET surface area of the lithium carbonate particles may have increased no less than 5 fold; no less than 10 fold; no less than 15 fold; no less than 20 fold; no less than 25 fold; no less than 30 fold; no less than 35 fold; no less than 40 fold; no less than 45 fold; no less than 50 fold; no less than 55 fold; or no less than 60 fold.

For exemplary methods, after the second process, the lithium particles may have a Dᵥ (50) between 0.08 μm and 0.43 μm and a Dₙ (50) between 0.015 μm and 0.5 μm.

### IV. Exemplary Applications of Lithium Carbonate Particles

Exemplary applications of lithium carbonate (Li₂CO₃) particles may include batteries, such as lithium-ion secondary batteries. Exemplary lithium-ion batteries include an anode, a cathode, and a nonaqueous electrolyte.

In various instances, the lithium carbonate particles may be present in a slurry at a weight percent (wt %) of 0.20 wt % to 1.20 wt %. As used herein, a “slurry” includes anode or cathode active materials, one or more binder materials, one or more carbon materials, one or more solvent media, and the lithium carbonate. In various instances, the lithium carbonate particles may be present in a slurry at a weight percent of 0.20 wt % to 1.10 wt %; 0.30 wt % to 1.00 wt %; 0.40 wt % to 0.90 wt %; 0.50 wt % to 0.80 wt %; or 0.60 wt % to 0.70 wt %. In various instances, the lithium carbonate particles may be present in a slurry at a weight percent of no greater than 1.20 wt %; no greater than 1.10 wt %; no greater than 1.00 wt %; no greater than 0.90 wt %; no greater than 0.80 wt %; no greater than 0.70 wt %; no greater than 0.60 wt %; no greater than 0.50 wt %; no greater than 0.40 wt %; no greater than 0.30 wt %; or no greater than 0.20 wt %. In various instances, the lithium carbonate particles may be present in a slurry at a weight percent of no less than 0.20 wt %; no less than 0.30 wt %; no less than 0.40 wt %; no less than 0.50 wt %; no less than 0.60 wt %; no less than 0.70 wt %; no less than 0.80 wt %; no less than 0.90 wt %; no less than 1.00 wt %; no less than 1.10 wt %; or no less than 1.20 wt %.

### A. Anode

Exemplary anodes may generally comprise an anode active material layer and an anode current collector. Exemplary anode active material layers may comprise an anode active material, a binder, and a conductive material. Exemplary anode active materials are not particularly limited, and may comprise carbon, such as natural or artificial graphite. In various instances, the anode active material may be a carbon composite, such as a silicon graphite composite (“Si/graphite”).

Exemplary anode active material layers may comprise 90 wt % to 99 wt % anode active material. In various instances, exemplary anodes may comprise 91 wt % to 99 wt % anode active material; 92 wt % to 98 wt % anode active material; 93 wt % to 97 wt % anode active material; or 94 wt % to 96 wt % anode active material. In various instances, exemplary anode anode active material layers may comprise no greater than 99 wt % anode active material; no greater than 98 wt % anode active material; no greater than 97 wt % anode active material; no greater than 96 wt % anode active material; no greater than 95 wt % anode active material; no greater than 94 wt % anode active material; no greater than 93 wt % anode active material; no greater than 92 wt % anode active material; no greater than 91 wt % anode active material; or no greater than 90 wt % anode active material. In various instances, exemplary anode active material layers may comprise no less than 90 wt % anode active material; no less than 91 wt % anode active material; no less than 92 wt % anode active material; no less than 93 wt % anode active material; no less than 94 wt % anode active material; no less than 95 wt % anode active material; no less than 96 wt % anode active material; no less than 97 wt % anode active material; no less than 98 wt % anode active material; or no less than 99 wt % anode active material.

Exemplary anodes may be manufactured by coating an anode slurry containing the anode active material layer components (which may include anode active material, binder, and conductive material) onto a current collector, and drying the slurry on the current collector. The anode active material layer may be further compacted on the current collector using pressing methods known to those of ordinary skill in the art.

### B. Cathode

Exemplary cathodes may generally comprise a cathode active material layer and a cathode current collector. Exemplary cathode active material layers may comprise a cathode active material, a binder, a conductive material, and the lithium carbonate (Li₂CO₃) particles described herein. Exemplary cathode active materials are not particularly limited, and may comprise a lithium metal oxide (e.g., LiNi_{0.8}Co_{0.1}Mn_{0.1}O₂).

Exemplary cathodes may comprise 90 wt % to 99 wt % cathode active material. In various instances, exemplary cathodes may comprise 91 wt % to 99 wt % cathode active material; 92 wt % to 98 wt % cathode active material; 93 wt % to 97 wt % cathode active material; or 94 wt % to 96 wt % cathode active material. In various instances, exemplary cathodes may comprise no greater than 99 wt % cathode active material; no greater than 98 wt % cathode active material; no greater than 97 wt % cathode active material; no greater than 96 wt % cathode active material; no no greater than 95 wt % cathode active material; no greater than 94 wt % cathode active material; no greater than 93 wt % cathode active material; no greater than 92 wt % cathode active material; no greater than 91 wt % cathode active material; or no greater than 90 wt % cathode active material. In various instances, exemplary cathodes may comprise no less than 90 wt % cathode active material; no less than 91 wt % cathode active material; no less than 92 wt % cathode active material; no less than 93 wt % cathode active material; no less than 94 wt % cathode active material; no less than 95 wt % cathode active material; no less than 96 wt % cathode active material; no less than 97 wt % cathode active material; no less than 98 wt % cathode active material; or no less than 99 wt % cathode active material.

Exemplary cathodes may comprise lithium carbonate (Li₂CO₃) particles, prepared using methods described herein, at a weight percent (wt %) of 0.20 wt % to 1.20 wt %. In various instances, the lithium carbonate (Li₂CO₃) particles may be present in the cathode at a weight percent of 0.20 wt % to 1.10 wt %; 0.30 wt % to 1.00 wt %; 0.40 wt % to 0.90 wt %; 0.50 wt % to 0.80 wt %; or 0.60 wt % to 0.70 wt %. In various instances, the lithium carbonate (Li₂CO₃) particles may be present in the cathode at a weight percent of no greater than 1.20 wt %; no greater than 1.10 wt %; no greater than 1.00 wt %; no greater than 0.90 wt %; no greater than 0.80 wt %; no greater than 0.70 wt %; no greater than 0.60 wt %; no greater than 0.50 wt %; no greater than 0.40 wt %; no greater than 0.30 wt %; or no greater than 0.20 wt %. In various instances, the lithium carbonate (Li₂CO₃) particles may be present in the cathode at a weight percent of no less than 0.20 wt %; no less than 0.30 wt %; no less than 0.40 wt %; no less than 0.50 wt %; no less than 0.60 wt %; no less than 0.70 wt %; no less than 0.80 wt %; no less than 0.90 wt %; no less than 1.00 wt %; no less than 1.10 wt %; or no less than 1.20 wt %.

Exemplary cathodes may be manufactured by coating a cathode slurry containing the cathode active material layer components (which may include cathode active material, binder, conductive material, and lithium carbonate (Li₂CO₃) particles) onto a cathode current collector and drying the slurry on the current collector. The cathode active material layer may be further compacted on the current collector using pressing methods known to those of ordinary skill in the art. Exemplary cathode slurries may be manufactured by combining the cathode active material layer components (cathode active material, binder, and conductive material) and adding a suitable solvent (e.g., N-methyl pyrrolidone).

### C. Electrolyte

Non-aqueous electrolytes for lithium-ion batteries that include lithium carbonate (Li₂CO₃) particles as described herein are not particularly limited. Generally, exemplary non-aqueous electrolytes comprise at least one lithium (Li) salt and a non-aqueous solvent.

Exemplary lithium-ion secondary batteries may be manufactured by using methods known to those of ordinary skill in the art.

### V. Experimental Examples

Without limiting the scope of the instant disclosure, various experimental examples of embodiments discussed above were prepared and results are discussed below.

### Example 1: Li₂CO₃ Particle Size Change Upon Sand-Milling

Particle size measurement for lithium carbonate (Li₂CO₃) samples (samples A-F and F-L) was conducted using laser particle size analysis. For the following sand-milling tests 0.2 g of each lithium carbonate sample was dispersed in 10 mL ethanol. Each sample was analyzed via Malvern laser particle size analyzer, the background was removed, then added to 600 mL and processed until 8-15% overshadow was observed.

Lithium carbonate (Li₂CO₃) samples (samples A-F and F-L) were sand-milled for various time periods and the resulting lithium carbonate particle sizes Dᵥ (50) (μm) and D_{N} (50) (μm) were measured. Pre-milling, to prepare the samples 0.9 kg of raw lithium carbonate (Li₂CO₃) was added to 4 kg of ethanol (EtOH) in a 20-liter mixer and was mixed at 30-2500 rpm for 15 minutes. The sand milling mixing speed for all samples was 1000 rpm.

TABLE 1
Lithium carbonate particle sizes
(Dᵥ (50) and D_{N} (50)) for Samples A-F.

| Sample | A0 | B | C | D | E | F |
|---|---|---|---|---|---|---|
| Condition | 0 min | 2 min | 5 min | 10 min | 20 min | 30 min |
| Dᵥ (50) (μm) | 6.95 | 5.85 | 5.70 | 5.13 | 4.19 | 3.99 |
| D_{N} (50) (μm) | 3.47 | 2.91 | 2.73 | 2.54 | 2.22 | 2.05 |

TABLE 2
Lithium carbonate particle sizes (Dᵥ (50) and D_{N} (50)) for Samples F-L.

| Sample | F | G | H | I | J | K | L |
|---|---|---|---|---|---|---|---|
| Condition | 30 min | 30 min | 90 min | 150 min | 210 min | 270 min | 390 min |
| Dᵥ (50) (μm) | 3.99 | 4.13 | 1.69 | 0.428 | 0.378 | 0.27 | 0.133 |
| D_{N} (50) (μm) | 2.05 | 2.07 | 0.0161 | 0.0161 | 0.0161 | 0.0161 | 0.0161 |

### Example 2: BET Surface Area

The BET surface area measurement method used for determining the following BET surface areas was based on GB/T 19587-2004. Raw lithium carbonate (Li₂CO₃) particles having an initial BET surface area of 0.78 m²/g and 0.3 wt % impurities was sand milled for 10-minute, 30-minute, 90-minute, 150-minute, 210-minute, 270-minute, and 390-minute time periods (samples D, F, H, I, J, K, and L respectively). The resulting BET surface area was measured for each of the milled lithium carbonate samples. BET surface area was measured using a Tristar 2030 machine, using test standard GBIT 19587-2017 “Determination of the specific surface area of solids by gas adsorption using the BET method.” Generally, the test methods included using a 0.3 g-1 g sample, heating to 200° C. and degassing the sample for 2 hours, and then measuring surface areas with a standard nitrogen system after degassing.

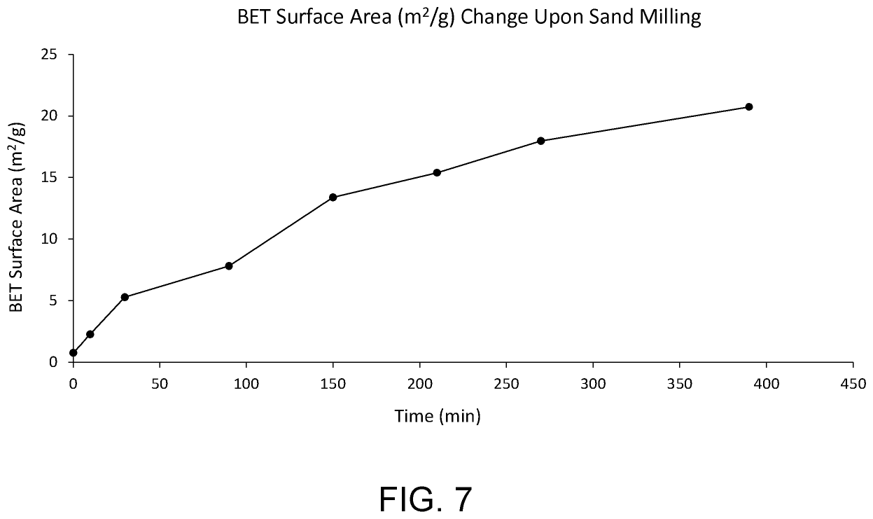

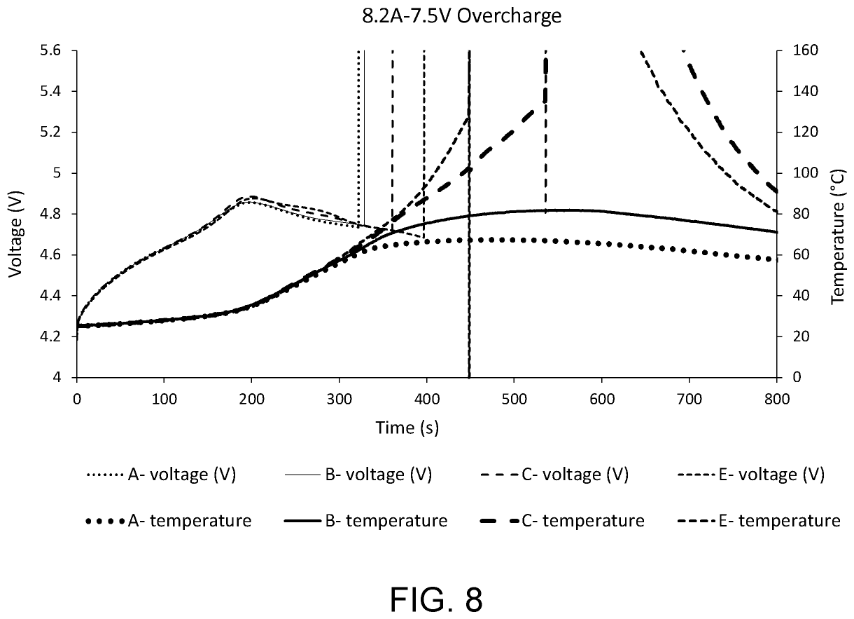

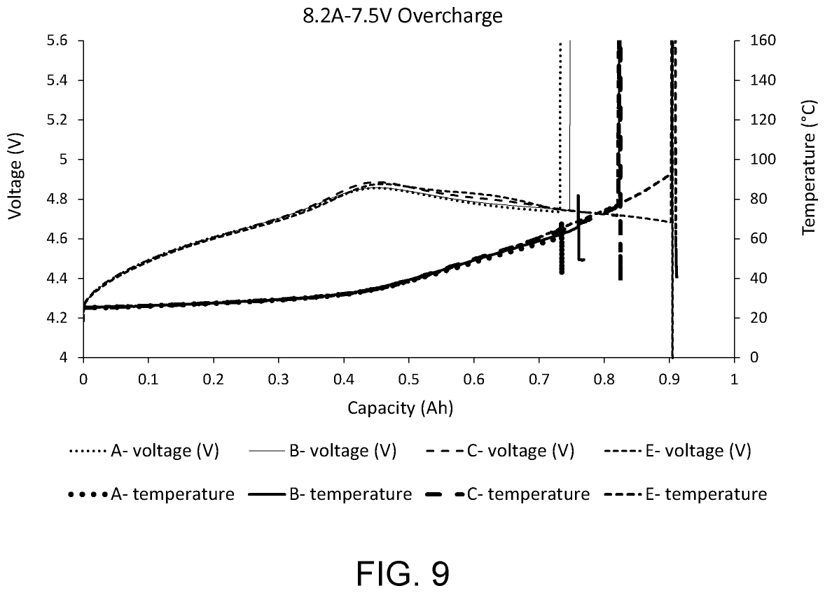

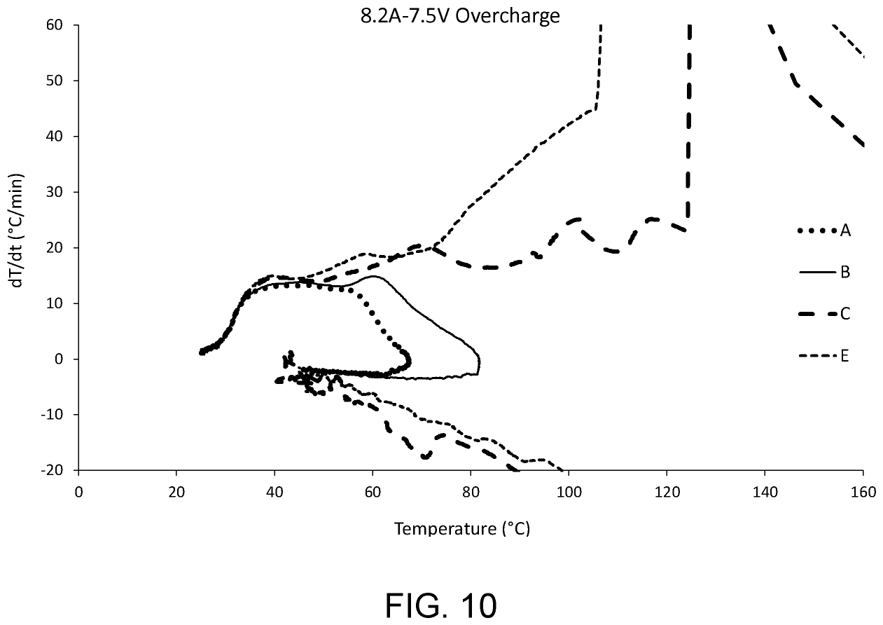

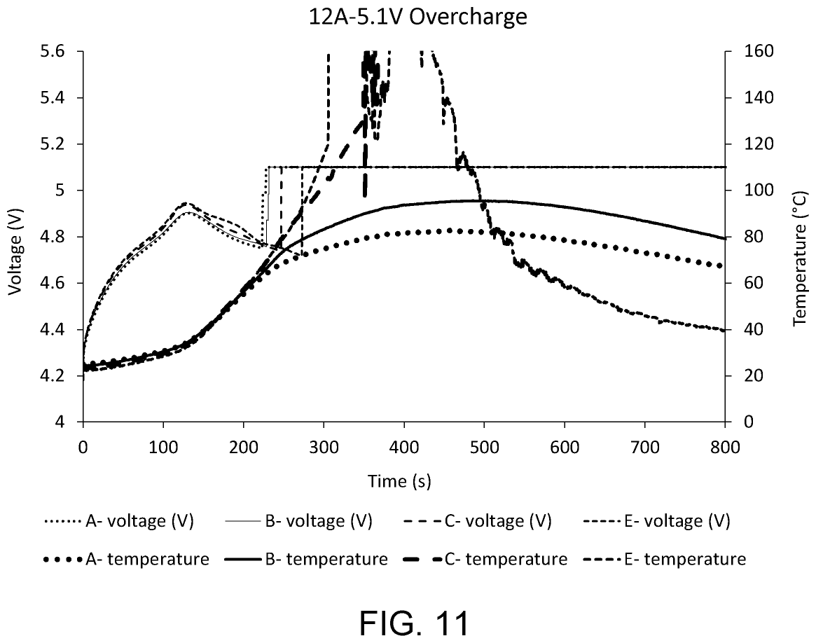

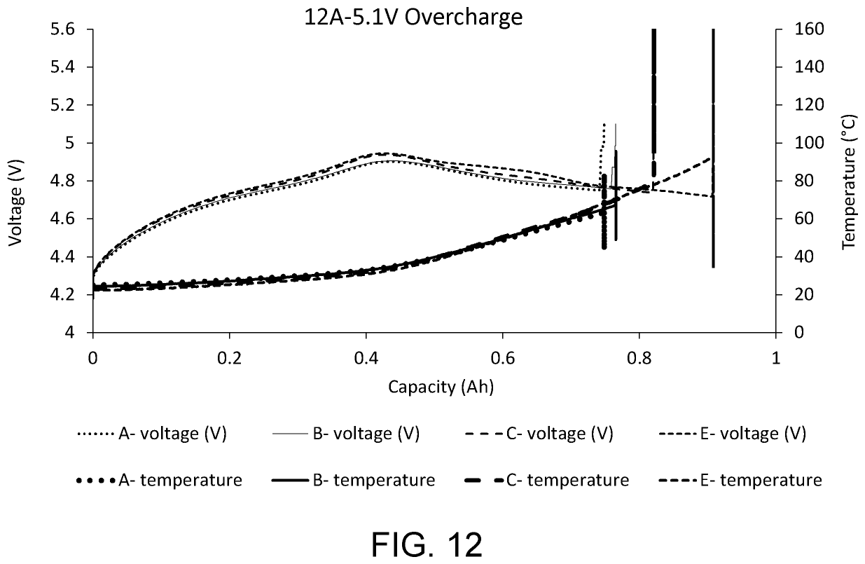

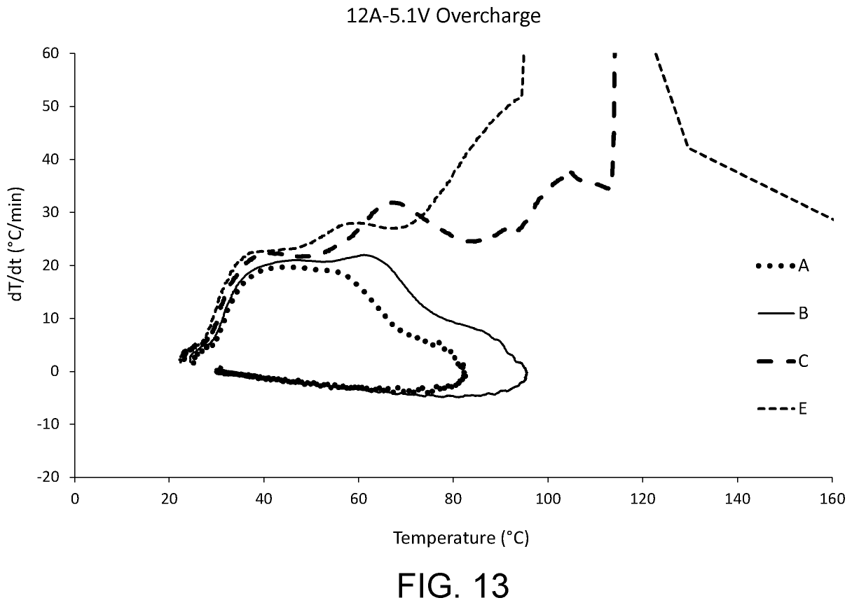

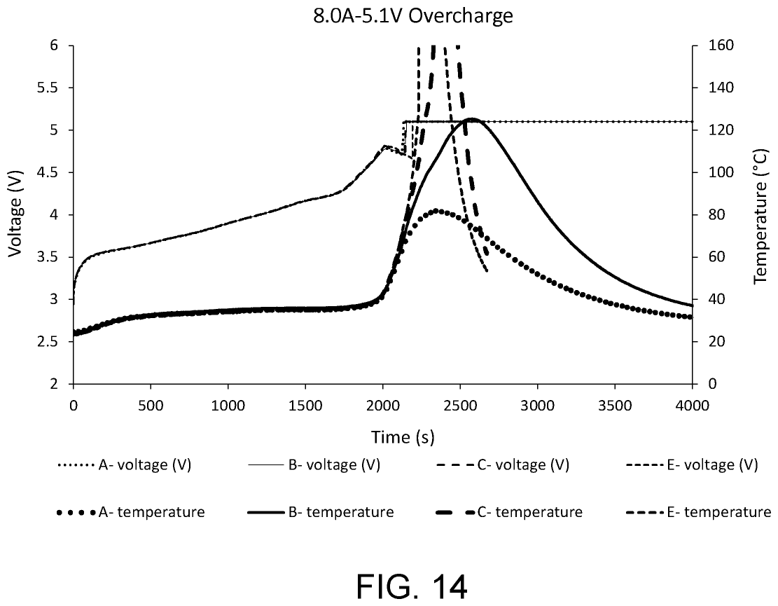

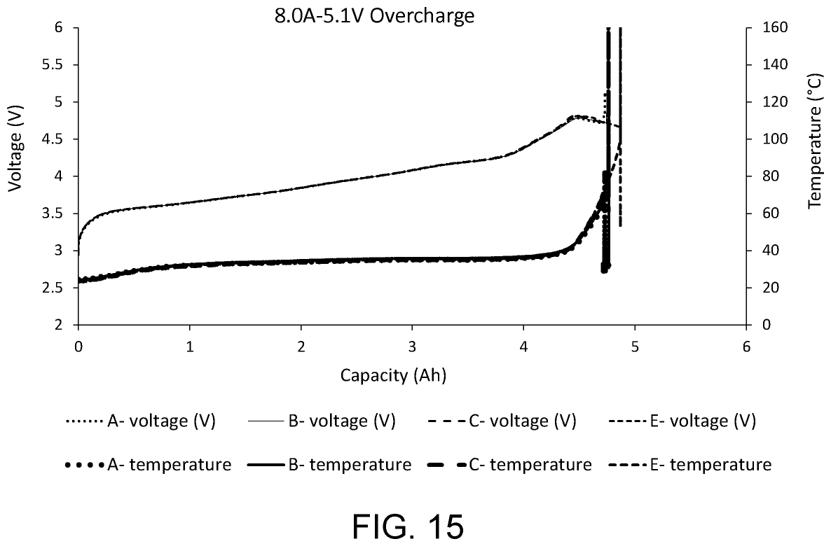

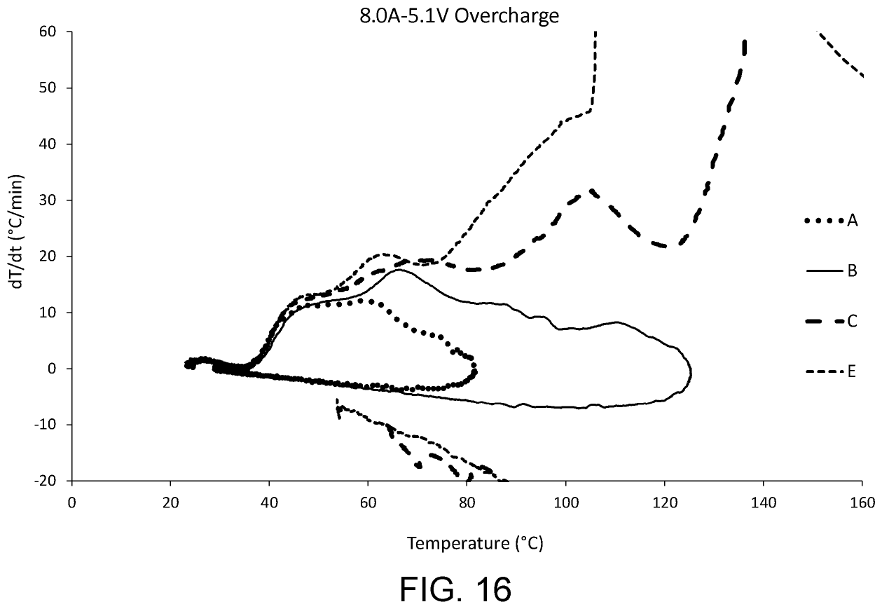

The BET surface area results are shown in Table 3 and FIG. 7. As shown in Table 3 below, after milling the Sample L lithium carbonate for a 390-minute period, the BET surface area was 20.74 m²/g. Without wishing to be bound by a particular theory, the inventors hypothesize that milling for longer time periods (>390 minutes) could achieve BET surface areas up to 40 m²/g.

TABLE 3
Lithium carbonate particle BET surface area for Samples A0-L.

| Sample | A0 | D | F | H | I | J | K | L |
|---|---|---|---|---|---|---|---|---|
| Condition | Raw | 10 | 30 | 90 | 150 | 210 | 270 | 390 |
| | material | min | min | min | min | min | min | min |
| BET surface | 0.78 | 2.27 | 5.58 | 7.82 | 13.39 | 15.39 | 17.97 | 20.74 |
| area (m²/g) | | | | | | | | |

### Example 3: Overcharge Tests

For the following overcharge experiments, group A, B, C, and E lithium-ion batteries were tested. Group A batteries were prepared with 1 wt % lithium carbonate. Group B batteries were prepared with 0.5 wt % lithium carbonate. The lithium carbonate used in Group A batteries and in Group B batteries was the Sample L lithium carbonate, Table 3 above, where the lithium carbonate was prepared via milling for 390 minutes.

Group C batteries were prepared with 1 wt % lithium carbonate, wherein the lithium carbonate was not prepared via milling (Sample A0, Table 3 above). For the lithium batteries used for the following overcharge experiments, LiNi_{0.8}Co_{0.1}Mn_{0.1}O₂ was used as the cathode active material, silicon graphite composite was used as the anode active material, and LiPF₆ in ethylene carbonate (EC)/dimethyl carbonate (DMC)/fluoroethylene carbonate (FEC) was used as the electrolyte. Tables 4-6 show the results of the three overcharge experiments (8.2 A-7.5V (100% SOC), 12.0 A-5.1V (100% SOC), and 8.0 A-5.1V (0% SOC)).

TABLE 4
8.2 A-7.5 V (100% SOC) Overcharge Test (CID = current
interrupt device, SOC = state of charge)

| 8.2 A-7.5 V | | | | |
|---|---|---|---|---|
| (100% SOC) Test | A | B | C | E |
| Status | Pass | Pass | Fail | Fail |
| CID open time | 322/322/323 | 328/337/335 | 360 | 396 |
| (seconds (s)) | | | | |
| CID open capacity | 0.734/0.733/0.737 | 0.748/0.768/0.763 | 0.822 | 0.904 |
| (mAh) | | | | |
| CID open | 61.0/60.7/60.5 | 63.1/67.3/65.0 | 76.1 | 92.8 |
| temperature (° C.) | | | | |
| Cell maximum | 68.8/67.2/66.7 | 77.2/85.8/82.9 | >260 | >260 |
| temperature | | | | |
| (° C.) | | | | |
| Cell highest | 4.852/4.854/4.862 | 4.858/4.859/4.858 | 4.885 | 4.876 |
| voltage (V) | | | | |

TABLE 5
12.0 A-5.1 V (100% SOC) Overcharge Test (CID = current
interrupt device, SOC = state of charge)

| 12.0 A-5.1 V | | | | |
|---|---|---|---|---|
| (100% SOC) Test | A | B | C | E |
| Status | Pass | Pass | Fail | Fail |
| CID open time | 224/223/228 | 231/232/229 | 247 | 273 |
| (seconds (s)) | | | | |
| CID open capacity | 0.745/0.743/0.768 | 0.768/0.769/0.760 | 0.821 | 0.908 |
| (mAh) | | | | |
| CID open | 60.8/62.3/66.2 | 67.2/67.3/66.7 | 79.0 | 92.6 |
| temperature (° C.) | | | | |
| Cell maximum | 77.5/78.5/93.5 | 94.1/99.9/93.5 | >260 | >260 |
| temperature | | | | |
| (° C.) | | | | |
| Cell highest | 4.913/4.896/4.898 | 4.917/4.904/4.898 | 4.938 | 4.945 |
| voltage (V) | | | | |

TABLE 6
8.0 A-5.1 V (0% SOC) Overcharge Test (CID = current
interrupt device, SOC = state of charge)

| 8.0 A-5.1 V | | | | |
|---|---|---|---|---|
| (0% SOC) Test | A | B | C | E |
| Status | Pass | Pass | Fail | Fail |
| CID open time | 2125/2132/2131 | 2152/2145/2135 | 2144 | 2191 |
| (seconds (s)) | | | | |
| CID open capacity | 4.718/4.735/4.734 | 4.780/4.765/4.738 | 4.762 | 4.868 |
| (mAh) | | | | |
| CID open | 65.3/63.6/64.8 | 70.1/72.6/71.8 | 76.5 | 99.0 |
| temperature (° C.) | | | | |
| Cell maximum | 84.2/82.4/79.7 | 114.8/142.5/119.5 | >260 | >260 |
| temperature | | | | |
| (° C.) | | | | |
| Cell highest | 4.783/4.782/4.784 | 4.790/4.771/4.786 | 4.813 | 4.810 |
| voltage (V) | | | | |

As shown above, groups A and B passed all three overcharge tests, while groups C and E failed in all three overcharge tests. As shown from the comparative data between groups A and B and groups C and D, the addition of the milled Li₂CO₃ particles, which have a large surface area (21.1 m²/g), accelerates gas generation rate during the overcharge process thus decreasing the corresponding current interrupt device (CID) open time and CID open temperature.

Comparing the three types of overcharge tests (8.2 A-7.5V (100% SOC), 12.0 A-5.1V (100% SOC), and 8.0 A-5.1V (0% SOC)), the 8.2 A-5.1V overcharge test starts from 0% state of charge (SOC) and causes more heat generation, which results is a higher cell maximum temperature than the 8.2 A-7.5V and the 12.0 A-5.1V overcharge tests, which start from 100% state of charge (SOC). Comparing the 8.2 A-7.5V overcharge test data with the 12.0 A-5.1V overcharge test data indicates that an increase in charge current decreases CID open time.

The foregoing description of the specific aspects will so fully reveal the general nature of the technology that others can, by applying knowledge within the skill of the art, readily modify and/or adapt for various applications such specific aspects, without undue experimentation, without departing from the general concept of the present disclosure. Therefore, such adaptations and modifications are intended to be within the meaning and range of equivalents of the disclosed aspects, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present disclosure should not be limited by any of the above-described exemplary aspects but should be defined only in accordance with the following claims and their equivalents.

All publications, patents, patent applications, and/or other documents cited in this application are incorporated by reference in their entirety for all purposes to the same extent as if each individual publication, patent, patent application, and/or other document were individually indicated to be incorporated by reference for all purposes.

For reasons of completeness, various aspects of the technology are set out in the following numbered embodiments:

Embodiment 1. A plurality of lithium carbonate (Li₂CO₃) particles, comprising:
at least 98% by weight (wt %) lithium carbonate, the particles having:
   a Dᵥ (50) between 0.08 μm and 0.43 μm;
   a Dₙ (50) between 0.015 μm and 0.5 μm; and
   a BET surface area between 10 m²/g and 25 m²/g.

Embodiment 2. The lithium carbonate (Li₂CO₃) particles according to embodiment 1, wherein the Dᵥ (50) is between 0.15 μm and 0.35 μm.

Embodiment 3. The lithium carbonate (Li₂CO₃) particles according to embodiment 1 or 2, wherein the Dₙ (50) is between 0.03 μm and 0.3 μm.

Embodiment 4. The lithium carbonate (Li₂CO₃) particles according to any one of embodiments 1-3, wherein the BET surface area is between 15 m²/g and 25 m²/g.

Embodiment 5. The lithium carbonate (Li₂CO₃) particles according to any one of embodiments 1-4, wherein the BET surface area is between 17.5 m²/g to 22.5 m²/g.

Embodiment 6. The lithium carbonate (Li₂CO₃) particles according to any one of embodiments 1-5, wherein the lithium carbonate particles comprise at least 99 wt % lithium carbonate.

Embodiment 7. A method of preparing lithium carbonate, comprising a first process followed by a second process, wherein the first process comprises:
forming a first lithium carbonate dispersion by combining lithium carbonate particles in a first dispersion medium, the lithium carbonate particles having a Dᵥ (50) between 5 μm and 8 μm;
forming a first milling suspension by adding a first plurality of zirconium oxide (ZrO₂) particles to the first lithium carbonate dispersion; and
milling the first milling suspension at a first predetermined speed for a first predetermined period of time, the first predetermined speed being between 500 rpm and 1500 rpm, and the first predetermined period of time being between 30 minutes and 300 minutes; and the second process comprises:
forming a second lithium carbonate dispersion by combining a plurality of lithium carbonate particles produced by the first process in a second dispersion medium,
forming a second milling suspension by adding a second plurality of zirconium oxide (ZrO₂) particles to the second lithium carbonate dispersion; and
milling the second milling suspension at a second predetermined speed for a second predetermined period of time, the second predetermined speed being between 1000 rpm and 2000 rpm, and the second predetermined period of time being between 60 minutes and 600 minutes.

Embodiment 8. The method according to embodiment 7, wherein the first predetermined speed is 600 rpm to 1400 rpm, and the first predetermined period of time is between 50 minutes and 250 minutes.

Embodiment 9. The method according to embodiment 7 or 8, wherein the second predetermined speed is between 1200 rpm and 1800 rpm, and the second predetermined period of time is between 150 minutes and 550 minutes.

Embodiment 10. The method according to any one of embodiments 7-9, wherein the first dispersion medium comprises at least one of: methanol, ethanol, propanol, or N-methyl-2-pyrrolidone.

Embodiment 11. The method according to any one of embodiments 7-10, wherein the second dispersion medium comprises at least one of: methanol, ethanol, propanol, or N-methyl-2-pyrrolidone.

Embodiment 12. The method according to any one of embodiments 7-11, wherein the first plurality of zirconium oxide particles have an average diameter between 1.00 mm and 1.80 mm.

Embodiment 13. The method according to any one of embodiments 7-12, wherein the second plurality of zirconium oxide particles have an average diameter between 0.20 mm and 1.20 mm.

Embodiment 14. The method according to any one of embodiments 7-13, wherein after the second process, the lithium carbonate (Li₂CO₃) particles have a Dᵥ (50) between 0.08 μm and 0.43 μm and a Dₙ (50) between 0.015 μm and 0.5 μm.

Embodiment 15. The method according to any one of embodiments 7-14, further comprising before forming the first milling suspension, stirring the first lithium carbonate dispersion for 10 minutes to 20 minutes at 30 rpm to 1000 rpm.

Embodiment 16. The method according to any one of embodiments 7-15, further comprising before forming the second milling suspension, stirring the second lithium carbonate dispersion for 10 to 20 minutes at 1000 rpm to 2500 rpm.

Embodiment 17. The method according to any one of embodiments 7-16, wherein after the second process, a BET surface area of the lithium carbonate particles has increased between 5-fold and 67-fold.

Embodiment 18. The method according to any one of embodiments 7-17, wherein after the second process, the lithium carbonate particles have a BET surface area is between 10 m²/g and 25 m²/g.

Embodiment 19. A method of preparing lithium carbonate, comprising a first process followed by a second process, wherein the first process comprises:
forming a first lithium carbonate dispersion by combining lithium carbonate particles in a first dispersion medium, the lithium carbonate particles having a Dᵥ (50) between 5 μm and 8 μm;
forming a first milling suspension by adding a first plurality of zirconium oxide (ZrO₂) particles to the first lithium carbonate dispersion; and
milling the first milling suspension at a first predetermined speed for a first predetermined period of time, the first predetermined speed being between 600 rpm and 1400 rpm, and the first predetermined period of time being between 50 minutes and 250 minutes; and the second process comprises:
forming a second lithium carbonate dispersion by combining a plurality of lithium carbonate particles produced by the first process in a second dispersion medium,
forming a second milling suspension by adding a second plurality of zirconium oxide (ZrO₂) particles to the second lithium carbonate dispersion; and
milling the second milling suspension at a second predetermined speed for a second predetermined period of time, the second predetermined speed being between 1200 rpm and 1800 rpm, and the second predetermined period of time being between 150 minutes and 550 minutes, wherein after the second process,
wherein after the second process, the lithium carbonate particles have a BET surface area is between 15 m²/g and 25 m²/g.

Embodiment 20. The method according to embodiment 19, wherein after the second process, the lithium carbonate particles have a BET surface area is between 17.5 m²/g and 22.5 m²/g.

Embodiment 21. A battery, comprising:
an anode comprising an anode current collector and an anode active material layer, the anode active material layer comprising:
   a binder;
   a conductive material;
   an anode active material; and
a cathode comprising a cathode current collector and a cathode active material layer, the cathode active material layer comprising:
   a binder;
   a conductive material;
   a cathode active material; and
   a plurality of lithium carbonate (Li₂CO₃) particles, the particles having a BET surface area between 10 m²/g and 25 m²/g;
a separator sheet; and
a non-aqueous electrolyte.

Embodiment 22. The battery according to embodiment 21, wherein the anode comprises an anode active material, wherein the anode active material comprises a silicon carbon composite.

Embodiment 23. The battery according to embodiment 21 or 22, wherein the cathode active material comprises LiNi_{0.8}Co_{0.1}Mn_{0.1}O₂.

Embodiment 24. The battery according to any one of embodiments 21-23, wherein the lithium carbonate particles comprise at least 98 wt % lithium carbonate.

Embodiment 25. The battery according to any one of embodiments 21-24, wherein the lithium carbonate particles comprise at least 99 wt % lithium carbonate.

Embodiment 26. The battery according to any one of embodiments 21-25, wherein the BET surface area of the lithium carbonate particles is between 15 m²/g and 25 m²/g.

Embodiment 27. The battery according to any one of embodiments 21-26, wherein the BET surface area of the lithium carbonate particles is between 17.5 m²/g and 22.5 m²/g.

Embodiment 28. The battery of any one of embodiments 21-27, wherein the lithium carbonate particles have a Dₙ (50) between 0.08 μm and 0.43 μm.

Embodiment 29. The battery of any one of embodiments 21-28, wherein the lithium carbonate particles have a Dₙ (50) between 0.015 μm and 0.5 μm.

Embodiment 30. The battery according to any one of embodiments 21-29, wherein the cathode active material layer comprises 0.3 wt % to 1.0 wt % lithium carbonate particles.

Embodiment 31. A lithium-ion battery, the lithium-ion battery comprising:
an anode comprising an anode current collector and an anode active material layer, the anode active material layer comprising:
   a binder;
   a conductive material; and
   an anode active material;
a cathode comprising a cathode current collector and a cathode active material layer, the cathode active material layer comprising:
   a binder;
   a conductive material;
   a cathode active material; and
   a plurality of lithium carbonate (Li₂CO₃) particles, the particles having:
      a BET surface area between 10 m²/g and 25 m²/g;
a Dᵥ (50) between 0.08 μm and 0.43 μm; and
a Dₙ (50) between 0.015 μm and 0.5 μm;
a separator sheet; and
a non-aqueous electrolyte.

Embodiment 32. The lithium-ion battery according to embodiment 31, wherein the anode active material comprises a silicon carbon composite.

Embodiment 33. The lithium-ion battery according to embodiment 31 or 32, wherein the anode active material layer comprises 90 weight % (wt %) to 99 wt % of the silicon carbon composite.

Embodiment 34. The lithium-ion battery according to any one of embodiments 31-33, wherein the cathode active material comprises LiNi_{0.8}Co_{0.1}Mn_{0.1}O₂.

Embodiment 35. The lithium-ion battery according to any one of embodiments 31-34, wherein the cathode active material layer comprises 90 wt % to 99 wt % LiNi_{0.8}Co_{0.1}Mn_{0.1}O₂.

Embodiment 36. The lithium-ion battery according to any one of embodiments 31-35, wherein the cathode active material layer comprises 0.3 wt % to 1.0 wt % lithium carbonate particles.

Embodiment 37. The lithium-ion battery according to any one of embodiments 31-36, wherein the BET surface area of the lithium carbonate particles is between 15 m²/g and 25 m²/g.

Embodiment 38. The lithium-ion battery according to any one of embodiments 31-37, wherein the BET surface area of the lithium carbonate particles is between 17.5 m²/g and 22.5 m²/g.

Embodiment 39. The lithium-ion battery according to any one of embodiments 31-38, wherein the battery is a jelly-roll type battery.

Embodiment 40. A method of making a cathode for a lithium-ion battery, the method comprising coating a cathode slurry onto a cathode current collector,
the cathode slurry comprising:
   a binder;
   a conductive material;
   a cathode active material; and
   a plurality of lithium carbonate (Li₂CO₃) particles, the particles having a BET surface area between 10 m²/g and 25 m²/g.

Embodiment 41. The method according to embodiment 40, wherein the BET surface area of the lithium carbonate particles is between 15 m²/g and 25 m²/g.

Embodiment 42. The method according to embodiment 40 or 41, wherein the BET surface area of the lithium carbonate particles is between 17.5 m²/g and 22.5 m²/g.

Embodiment 43. The method according to any one of embodiments 40-42, wherein the lithium carbonate particles have a Dᵥ (50) between 0.08 μm and 0.43 μm.

Embodiment 44. The method according to any one of embodiments 40-43, wherein the lithium carbonate particles have a Dₙ (50) between 0.015 μm and 0.5 μm.

Embodiment 45. The method according to any one of embodiments 40-44, wherein the cathode slurry comprises 0.3 wt % to 1.0 wt % lithium carbonate particles.

Embodiment 46. The method according to any one of embodiments 40-45, wherein the cathode active material comprises LiNi_{0.8}Co_{0.1}Mn_{0.1}O₂.

Embodiment 47. The method according to any one of embodiments 40-46, wherein the cathode slurry comprises 90 wt % to 99 wt % LiNi_{0.8}Co_{0.1}Mn_{0.1}O₂.

Embodiment 48. A method of making a battery comprising the method of making the cathode according to any one of embodiments 40-47, the method of making the battery further comprising a method of making an anode, the method of making an anode comprising coating an anode slurry onto an anode current collector,
the anode slurry comprising:
   a binder;
   a conductive material; and
   an anode active material.

Embodiment 49. The method according to embodiment 48, wherein the anode active material comprises a silicon carbon composite.

Embodiment 50. The method according to embodiment 48 or 49, wherein the anode slurry comprises 90 wt % to 99 wt % of the silicon carbon composite.

1-50. (canceled)

51. A plurality of lithium carbonate (Li₂CO₃) particles, comprising:
at least 98% by weight (wt %) lithium carbonate, the plurality of lithium carbonate (Li₂CO₃) particles having:
a Dᵥ (50) between 0.08 μm and 0.43 μm;
a Dₙ (50) between 0.015 μm and 0.5 μm; and
a BET surface area between 10 m²/g and 25 m²/g.

52. The plurality of lithium carbonate (Li₂CO₃) particles according to claim 1, wherein the Dᵥ (50) is between 0.15 μm and 0.35 μm; and/or the Dₙ (50) is between 0.03 μm and 0.3 μm.

53. The plurality of lithium carbonate (Li₂CO₃) particles according to claim 1, wherein the BET surface area is between 15 m²/g and 25 m²/g, preferably, between 17.5 m²/g to 22.5 m²/g.

54. The plurality of lithium carbonate (Li₂CO₃) particles according to claim 1, wherein the lithium carbonate particles comprise at least 99 wt % lithium carbonate.

55. A method of preparing lithium carbonate particles, comprising:
a first process and second process, the first process comprising:
forming a first lithium carbonate dispersion by combining lithium carbonate particles in a first dispersion medium, the lithium carbonate particles having a Dᵥ (50) between 5 μm and 8 μm;
forming a first milling suspension by adding a first plurality of zirconium oxide (ZrO₂) particles to the first lithium carbonate dispersion; and
milling the first milling suspension at a first predetermined speed for a first predetermined period of time, the first predetermined speed being between 500 rpm and 1500 rpm, and the first predetermined period of time being between 30 minutes and 300 minutes; and
the second process comprising:
forming a second lithium carbonate dispersion by combining a plurality of lithium carbonate particles produced by the first process in a second dispersion medium;
forming a second milling suspension by adding a second plurality of zirconium oxide (ZrO₂) particles to the second lithium carbonate dispersion; and
milling the second milling suspension at a second predetermined speed for a second predetermined period of time, the second predetermined speed being between 1000 rpm and 2000 rpm, and the second predetermined period of time being between 60 minutes and 600 minutes.

56. The method according to claim 5, wherein the first predetermined speed is 600 rpm to 1400 rpm, and the first predetermined period of time is between 50 minutes and 250 minutes; and/or the second predetermined speed is between 1200 rpm and 1800 rpm, and the second predetermined period of time is between 150 minutes and 550 minutes.

57. The method according to claim 5, wherein the first dispersion medium comprises at least one of: methanol, ethanol, propanol, or N-methyl-2-pyrrolidone; and/or the second dispersion medium comprises at least one of: methanol, ethanol, propanol, or N-methyl-2-pyrrolidone.

58. The method according to claim 5, wherein the first plurality of zirconium oxide particles have an average diameter between 1.00 mm and 1.80 mm; and/or the second plurality of zirconium oxide particles have an average diameter between 0.20 mm and 1.20 mm.

59. The method according to claim 5, wherein after the second process, the lithium carbonate (Li₂CO₃) particles have a Dᵥ (50) between 0.08 μm and 0.43 μm and a Dₙ (50) between 0.015 μm and 0.5 μm.

60. The method according to claim 5, further comprising before forming the first milling suspension, stirring the first lithium carbonate dispersion for 10 minutes to 20 minutes at 30 rpm to 1000 rpm; and/or further comprising before forming the second milling suspension, stirring the second lithium carbonate dispersion for 10 minutes to 20 minutes at 1000 rpm to 2500 rpm.

61. The method according to claim 5, wherein after the second process, a BET surface area of the lithium carbonate particles has increased between 5-fold and 67-fold.

62. The method according to claim 5, wherein after the second process, the lithium carbonate particles have a BET surface area between 10 m²/g and 25 m²/g, preferably, between 15 m²/g and 25 m²/g, more preferably, between 17.5 m²/g and 22.5 m²/g.

63. A battery, comprising:
an anode comprising an anode current collector and an anode active material layer, the anode active material layer comprising:
a binder;
a conductive material; and
an anode active material;
a cathode comprising a cathode current collector and a cathode active material layer, the cathode active material layer comprising:
a binder;
a conductive material;
a cathode active material; and
a plurality of lithium carbonate (Li₂CO₃) particles, the plurality of lithium carbonate (Li₂CO₃) particles having a BET surface area between 10 m²/g and 25 m²/g;
a separator sheet; and
a non-aqueous electrolyte.

64. The battery according to claim 13, wherein the lithium carbonate particles comprise at least 98 wt % lithium carbonate, preferably, at least 99 wt % lithium carbonate.

65. The battery according to claim 13, wherein the BET surface area of the lithium carbonate particles is between 15 m²/g and 25 m²/g, preferably, between 17.5 m²/g and 22.5 m²/g.

66. The battery of claim 13, wherein the lithium carbonate particles have a Dᵥ (50) between 0.08 μm and 0.43 μm; and/or the lithium carbonate particles have a Dₙ (50) between 0.015 μm and 0.5 μm.

67. The battery according to claim 13, wherein the cathode active material layer comprises 0.3 wt % to 1.0 wt % lithium carbonate particles.

68. The battery according to claim 13, wherein the anode comprises an anode active material comprising a silicon carbon composite; and
wherein the cathode active material comprises LiNi_{0.8}Co_{0.1}Mn_{0.1}O₂.

69. The battery according to claim 13, wherein the battery is a jelly-roll type battery.

70. The battery according to claim 13, wherein the anode active material layer comprises 90 weight % (wt %) to 99 wt % of the silicon carbon composite.
